(19) United States
(12) Patent Application Publication
(10) Pub. No.: US 2026/0115661 A1
(43) Pub. Date: Apr. 30, 2026

(54) CATALYST TREATMENT APPARATUS USING PLASMA AND EXHAUST GAS TREATMENT SYSTEM USING THE SAME

(71) Applicant: ENNOPIA, Jincheon-gun (KR)

(72) Inventor: Hong Kyoung KIM, Yongin-si (KR)

(21) Appl. No.: 18/957,586

(22) Filed: Nov. 22, 2024

(30) Foreign Application Priority Data
Oct. 24, 2024 (KR) 10-2024-0146498

(51) Int. Cl. B01D 53/86; B01D 47/06; B01D 53/00; B03C 3/019; B03C 3/08; B03C 3/12

(52) U.S. Cl. CPC B01D 53/8662; B01D 47/06; B01D 53/005; B01D 53/007; B03C 3/019; B03C 3/08; B03C 3/12; B01D 2257/2047; B01D 2257/2066; B01D 2258/0216; B01D 2259/818

(57) ABSTRACT

Provided are a catalyst treatment apparatus for heating an exhaust gas and decomposing perfluorocompounds using a catalyst, and an exhaust gas treatment system using the same. Even when an exhaust gas passes through a pretreatment wet-type treatment apparatus, the exhaust gas lacks oxygen, and a dust collecting operation is not smoothly performed at the rear due to the lack of oxygen. An exhaust gas charging unit charges fine particles in an exhaust gas by supplying air or oxygen. Thus, an operation of decomposing perfluorocompounds may be smoothly performed.

### CLAIM FOR PRIORITY

This application claims priority to Korean Patent Application No. 2024-0146498 filed on Oct. 24, 2024 in the Korean Intellectual Property Office (KIPO), the entire contents of which are hereby incorporated by reference.

### BACKGROUND

### 1. Technical Field

Example embodiments of the present inventive concept relate to an exhaust gas treatment apparatus using a catalyst, and more specifically, to a catalyst treatment apparatus which heats an exhaust gas and captures fine particles in advance, and an exhaust gas treatment system using the same.

### 2. Related Art

In semiconductor manufacturing processes or display manufacturing processes, various processes are performed in specific process chambers. For example, an etching process is performed in an inert atmosphere gas environment inside a specially designed chamber. There are various methods for etching processes. In display manufacturing processes, etching using plasma is mainly performed, and in semiconductor manufacturing processes, etching using gaseous etching gas is mainly performed.

In the etching process described above, the type and atmosphere of gases in a chamber are strictly controlled. In particular, the concentration of oxygen inside the chamber needs to be controlled to an extremely small amount. Typically, the concentration of oxygen inside the chamber is generated by leakage irrespective of the user's intention, but is normally controlled to less than 50 ppm.

After a process is completed, an exhaust gas generated inside the chamber flows into scrubber equipment to be subjected to a decomposition or removal operation. The decomposition or removal operation is commonly referred to as scrubbing. The exhaust gas includes various components, and large amounts of perfluorocompounds are used in an etching process or the like. For example, perfluorocompounds such as CF₄ or SF₆ are used. In particular, CF₄ needs to be decomposed using high-temperature thermal decomposition or a catalyst. In addition, the exhaust gas includes SiO₂, SiF₄, and a plurality of unidentified fine particles.

When an exhaust gas is treated using a catalyst, and fine particles are included in the exhaust gas, the fine particles reduce the operating performance of the catalyst and cause poisoning. In particular, the fine particles are adsorbed onto a surface of the catalyst and reduce the activity of the catalyst. In order to solve such problems, the fine particles need to be sufficiently removed before the exhaust gas is supplied to the catalyst.

Fine particulates are removed through a wet dust collecting operation. In particular, the wet dust collecting operation is very effective in removing fine particles. In order to perform a dust collecting operation, a charging operation is required to ionize fine particles. However, in a situation in which an exhaust gas is deficient in oxygen, a charging operation through discharging is not performed, and a nearly perfect insulated state is made between electrodes due to a large amount of inert gas components included in the exhaust gas. Therefore, an electric field is not substantially applied, and a charging operation is not performed on the exhaust gas.

As described above, it is difficult to collect fine particles from the exhaust gas deficient in oxygen, and even when a catalyst is used to decompose perfluorocompounds included in the exhaust gas, it is difficult to achieve an effective heating operation.

### SUMMARY

Example embodiments of the present inventive concept are directed to providing a catalyst treatment apparatus capable of effectively collecting fine particles and rapidly heating an exhaust gas to decompose perfluorocompounds.

In addition, example embodiments of the present inventive concept are directed to providing an exhaust gas treatment system using the catalyst treatment apparatus provided by achieving the technical problem.

In some example embodiments, a catalyst treatment apparatus includes an exhaust gas charging unit configured to charge a charging gas including oxygen to form a charged gas, a dust collecting unit into which a mixed gas, in which a second exhaust gas including 1 vol % or less of oxygen is mixed with the charged gas, flows to perform a dust collecting operation, and a catalyst treatment unit configured to heat perfluorocompounds in a third exhaust gas exhausted from the dust collecting unit and decompose the perfluorocompounds using a catalyst.

In other example embodiments, an exhaust gas treatment system includes a pretreatment wet-type treatment apparatus configured to remove SiO₂ particles, SiF₄ gas, or HF gas included in a first exhaust gas generated in an etching process, a catalyst treatment apparatus configured to remove perfluorocompounds in a second exhaust gas exhausted from the pretreatment wet-type treatment apparatus, and a posttreatment wet-type treatment apparatus configured to remove the HF gas included in a first treatment gas exhausted from the catalyst treatment apparatus and generated by decomposing the perfluorocompounds.

### BRIEF DESCRIPTION OF DRAWINGS

Example embodiments of the present inventive concept will become more apparent by describing in detail example embodiments of the present inventive concept with reference to the accompanying drawings, in which:

FIG. 1 is a block diagram of an exhaust gas treatment system to which a catalyst treatment apparatus is applied according to an example embodiment of the present inventive concept;

FIG. 2 is a block diagram illustrating a catalyst treatment apparatus according to an example embodiment of the present inventive concept;

FIG. 3 is a cross-sectional view illustrating an exhaust gas charging unit of FIG. 2 according to an example embodiment of the present inventive concept;

FIG. 4 is a cross-sectional view illustrating a dust collecting unit of FIG. 2 according to an example embodiment of the present inventive concept;

FIG. 5 is a cross-sectional view illustrating a catalyst treatment unit of FIG. 2 according to an example embodiment of the present inventive concept;

FIG. 6 is a cross-sectional view for describing operations of the catalyst treatment unit and a heat exchange unit according to an example embodiment of the present inventive concept;

FIG. 7 is a perspective view illustrating the heat exchange unit according to an example embodiment of the present inventive concept;

FIG. 8 is a perspective view illustrating a heat transfer plate of FIG. 7 according to an example embodiment of the present inventive concept;

FIG. 9 is a cross-sectional view along line A-A′ of the shape of two bonded heat transfer plates of FIG. 8 according to an example embodiment of the present inventive concept; and

FIG. 10 shows a cross-sectional view along line B-B′ and a cross-sectional view along line C-C′ of the shape of two bonded heat transfer plates of FIG. 8 according to an example embodiment of the present inventive concept.

### DESCRIPTION OF EXAMPLE EMBODIMENTS

Since the present inventive concept can apply various transformations and have various embodiments, specific embodiments will be illustrated in the drawings and described in detail in the detailed description. However, it should be understood that this is not intended to limit the present inventive concept to specific embodiments, and the present inventive concept includes all transformations, equivalents, and substitutes included in the spirit and scope of the disclosure. In describing the drawings, similar reference numerals are used for similar elements.

Unless defined otherwise, all the terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present inventive concept will be described in detail with reference to the accompanying drawings.

### Embodiments

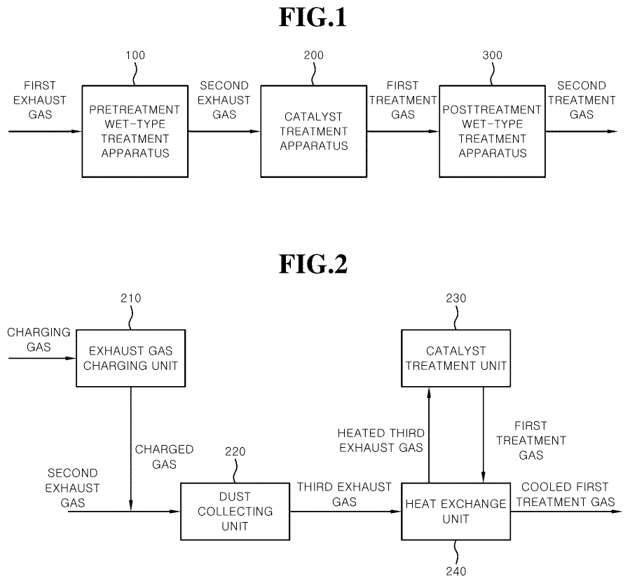

FIG. 1 is a block diagram of an exhaust gas treatment system to which a catalyst treatment apparatus is applied according to an example embodiment of the present inventive concept.

Referring to FIG. 1, the exhaust gas treatment system includes a pretreatment wet-type treatment apparatus 100, a catalyst treatment apparatus 200, and a posttreatment wet-type treatment apparatus 300.

A first exhaust gas generated from a semiconductor process apparatus flows into the pretreatment wet-type treatment apparatus 100. The first exhaust gas is a gas mainly generated in an etching process and includes less than 50 ppm of oxygen. In the present inventive concept, a concentration of oxygen does not refer to a concentration of oxygen atoms, but refers to a concentration of a gas that is present independently as oxygen gas.

In particular, when oxygen flows in during an etching process for polycrystalline silicon or an oxide, since the efficiency and precision of etching are degraded, the inflow of oxygen is blocked during the etching process, and a considerable portion of the exhaust gas consists of inert gases including nitrogen or the like. In addition, SiO₂ fine particles are included by etching, and perfluorocompounds such as CF₄, SiF₄, and SF6 are included.

In the pretreatment wet-type treatment apparatus 100, fine particles such as SiO₂ and unidentified solid particles are primarily removed through a wet scrubbing operation, and the pretreatment wet-type treatment apparatus 100 exhausts a second exhaust gas from which SiO₂ and the like have been removed from the first exhaust gas. However, despite wet scrubbing, some residual fine particles and SiO₂ particles may remain in the second exhaust gas.

The wet scrubbing operation is an operation of spraying water droplets onto the first exhaust gas and causing the first exhaust gas to pass through a packing approximately consisting of spheres. Water is supplied to the packing so that solid particles in the first exhaust gas are adsorbed onto a surface of the packing and removed. Thus, the second exhaust gas is exhausted from the pretreatment wet-type treatment apparatus 100. The second exhaust gas includes 1 vol % or less of oxygen. That is, during the wet scrubbing operation, external air or oxygen is not supplied and is blocked in order to sufficiently remove fine particles and the like included in the first exhaust gas.

The second exhaust gas flows into the catalyst treatment apparatus 200. The catalyst treatment apparatus 200 supplies ions to the second exhaust gas to perform a dust collecting operation and decomposes perfluorocompounds using a catalyst. A first treatment gas is formed through the decomposition of the perfluorocompounds.

Since the second exhaust gas is substantially free of oxygen, a dust collecting operation may not be performed on the second exhaust gas. The dust collecting operation is an operation of applying a high voltage to an exhaust gas to charge the exhaust gas and capture charged gases or particles at a dust collecting electrode. However, when there is no oxygen, even when a high voltage is applied to a discharge electrode to perform a charging operation, the gas remains perfectly insulated due to an inert gas included in the second exhaust gas. Therefore, a voltage is not applied due to an insulated state or electrical open state between the discharge electrode and the dust collecting electrode, and a charging operation is not performed on gases or particles.

Accordingly, the catalyst treatment apparatus 200 of the present inventive concept performs a dust collecting operation by additionally injecting a charged gas during the dust collecting operation. A gas on which the dust collecting operation has been performed is heated through plasma, and through a catalyst, perfluorocompounds are decomposed. The first treatment gas generated through the decomposition of the perfluorocompounds may include by-product gases such as HF or SiF₄.

The first treatment gas flows into the posttreatment wet-type treatment apparatus 300. In the posttreatment wet-type treatment apparatus 300, the by-product gases such as HF or SiF₄ included in the first treatment gas are removed to form a second treatment gas.

In FIG. 1, the pretreatment wet-type treatment apparatus and the posttreatment wet-type treatment apparatus are wet scrubbers, and any apparatus that uses a principle of spraying droplets onto a gas to be treated using water and performing a capturing operation can be applied.

FIG. 2 is a block diagram illustrating a catalyst treatment apparatus according to an example embodiment of the present inventive concept.

Referring to FIG. 2, the catalyst treatment apparatus includes an exhaust gas charging unit 210, a dust collecting unit 220, a catalyst treatment unit 230, and a heat exchange unit 240.

The exhaust gas charging unit 210 generates a charged gas. The generated charged gas is mixed with a second exhaust gas. The charged gas is ionized gas and mainly includes oxygen ions. The charged gas and the second exhaust gas are mixed to flow into the dust collecting unit 220.

In the dust collecting unit 220, a dust collecting operation may be performed using a voltage difference through application of a high voltage. An additional charging operation may be performed due to a voltage difference between a discharge electrode and a dust collecting electrode to which a high voltage is applied, and thus other exhaust gas components and fine particles excluding perfluorocompounds may be collected.

In the dust collecting unit 220, the dust collecting operation is performed, and a third exhaust gas is supplied to the heat exchange unit 240. The heat exchange unit 240 is connected to the catalyst treatment unit 230.

The heat exchange unit 240 is disposed between the dust collecting unit 220 and the catalyst treatment unit 230, and the third exhaust gas flows therein. Since the third exhaust gas has a temperature range of 150° C. to 250° C., the third exhaust gas is formed into a third exhaust gas heated to 470° C. or more through a heat exchange action in the heat exchange unit 240. The heat exchange action uses a first treatment gas with a temperature of about 650° C. to 740° C. formed in the catalyst treatment unit 230. The first treatment gas is formed into a first treatment gas cooled to a temperature of 230° C. to 280° C. through the heat exchange action. The cooled first treatment gas may flow into the posttreatment wet-type treatment apparatus of FIG. 1.

In addition, according to embodiments, the configuration of the heat exchange unit 240 may be omitted. When the configuration of the heat exchange unit 240 is omitted, the dust collecting unit 220 is directly connected to the catalyst treatment unit 230, the third exhaust gas exhausted from the dust collecting unit 220 flows into the catalyst treatment unit 230, an exhaust gas decomposing operation using a catalyst is performed, and the first treatment gas is generated. The formed first treatment gas flows into the posttreatment wet-type treatment apparatus of FIG. 1.

The catalyst treatment unit 230 heats the third exhaust gas or the heated third exhaust gas to a temperature of 700° C. or more using a plasma torch. The plasma torch that is used may not heat the exhaust gas with a high flow rate and may require an air flow rate of 2 cubic meter minutes (CMM) (m³/min) or less.

The inventors of the present inventive concept have confirmed through experiments that when an exhaust gas is supplied at a flow rate exceeding 2 CMM, a temperature of the third exhaust gas may not be sufficiently increased. Using a plurality of plasma torches to increase temperature is not effective. In the case of a plasma torch used in the art, a maximum diameter of a plasma flame is 50 mm at a used power of 20 kW. When a plurality of plasma torches are used, the power consumption of a system increases rapidly, and the volume of equipment increases, which causes a problem in that efficiency cannot be secured.

Therefore, in the present inventive concept, a single plasma torch is used to heat the third exhaust gas. Excluding perfluorocompounds, other gases may be decomposed by heating.

In addition, in the present inventive concept, in addition to plasma, another heating part may be used as a part for heating an exhaust gas. For example, the third exhaust gas may be heated to 700° C. or more using a heater.

The third exhaust gas heated to 700° C. or more may be converted into the first treatment gas through a catalyst. 95% or more of perfluorocompounds in the third exhaust gas are removed through the catalyst.

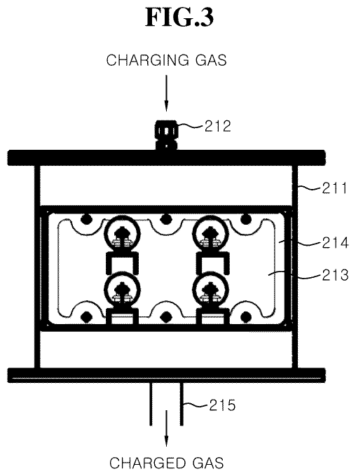

FIG. 3 is a cross-sectional view illustrating the exhaust gas charging unit of FIG. 2 according to an example embodiment of the present inventive concept.

Referring to FIG. 3, the exhaust gas charging unit includes a charging chamber 211, a charging gas inlet 212, a first electrode 213, a second electrode 214, and a charging gas outlet 215.

The charging gas inlet 212 is disposed at one side of the charging chamber 211 and allows a charging gas to flow into the charging chamber 211. In particular, the charging chamber 211 is electrically connected to the ground.

The first electrode 213 and the second electrode 214 are alternately disposed in the charging chamber 211 with a separation space therebetween. In addition, the electrodes are preferably a flat type and have a configuration in which a charging gas flows between the alternately disposed electrodes. As the charging gas flows in the separation space between the first electrode 213 and the second electrode 214, the charging gas may be charged. In particular, a high voltage is applied between the first electrode 213 and the second electrode 214, and one of the first electrode 213 and the second electrode 214 is grounded. The charging gas is charged by the high voltage applied between the electrodes, and ionized gases are generated.

The charging gas may be atmospheric gas, and any gas including 10% or more of oxygen may be used. In particular, oxygen is converted into ionized oxygen by the high voltage applied between the first electrode 213 and the second electrode 214. A charged gas including negative ions is exhausted through a charging gas exhaust port.

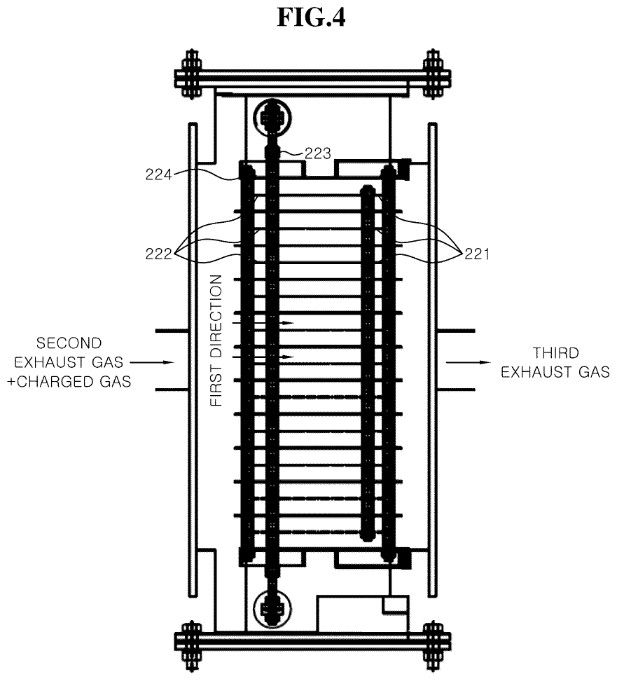

FIG. 4 is a cross-sectional view illustrating the dust collecting unit of FIG. 2 according to an example embodiment of the present inventive concept.

Referring to FIG. 4, the dust collecting unit may be disposed in a separate chamber or may be disposed in the same chamber as the exhaust gas charging unit of FIG. 3. However, a mixed gas in which the second exhaust gas and the charged gas are mixed is supplied to the dust collecting unit. The mixed gas is already in a charged state through the charged gas. The charged gas may be coupled to a portion of the second exhaust gas, and in particular, may be adsorbed onto a surface of fine particles to form ionized fine particles. Therefore, a separate charging operation may not be required, and a smooth dust collecting operation may be performed on the second exhaust gas that is substantially free of oxygen.

The dust collecting unit may include a discharge electrode 221 and a dust collecting electrode 222, and two types of electrodes 221 and 222 are alternately disposed to be spaced a certain interval from each other. The discharge electrode 221 is connected to a discharge frame 223, and a negative discharge voltage is applied thereto. The dust collecting electrode 222 is connected to a dust collecting frame 224, and the dust collecting electrode 222 is grounded or a positive voltage is applied thereto. Charged particles, which are negatively ionized by a voltage difference between the dust collecting electrode 222 and the discharge electrode 221, are captured by the dust collecting electrode.

A mixed gas in which the second exhaust gas and the charged gas are mixed flows in a first direction through the separation space between the electrodes 221 and 222. For the flow of the mixed gas, each frame does not completely block the separation space and forms a space in which the mixed gas may flow. Charged particles included in the mixed gas are captured on a surface of the dust collecting electrode 222, and the third exhaust gas is exhausted.

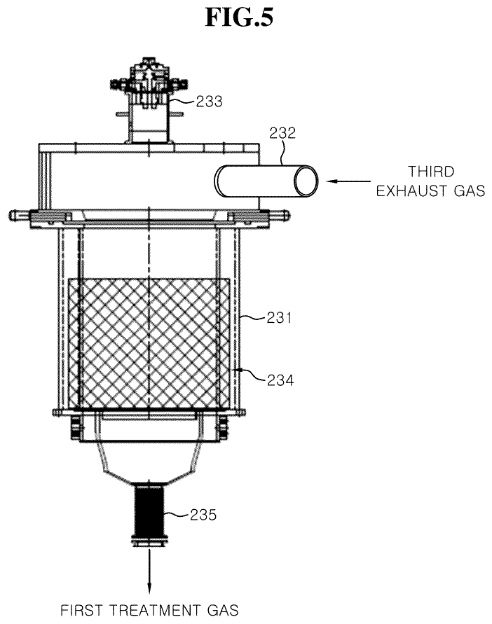

FIG. 5 is a cross-sectional view illustrating the catalyst treatment unit of FIG. 2 according to an example embodiment of the present inventive concept.

Referring to FIG. 5, the catalyst treatment unit includes a processing chamber 231, an exhaust gas inlet 232, a plasma supply unit 233, a catalyst unit 234, and a treatment gas outlet 235.

A key operation in the catalyst treatment unit is the decomposing of perfluorocompounds. A catalyst is used to decompose the perfluorocompounds, and it is preferable that the catalyst be an alumina-based catalyst. In order to decompose the perfluorocompounds using the catalyst, a temperature of the perfluorocompounds needs to be raised to 700° C. or more.

Typically, a heater is provided inside the processing chamber 231 to raise the temperature. Heaters have an advantage of being able to heat a space with a large volume, but are not suitable for rapidly heating exhaust gases. In addition, when a heater is installed inside to treat an exhaust gas with an air flow rate of 2 CMM or less, there is a problem in that the size of a processing chamber increases, and a time required to raise a temperature of the exhaust gas increases. In order to solve the above problem, in the present inventive concept, plasma is used.

Plasma may rapidly heat gases distributed in a relatively narrow space, and in the present inventive concept, nitrogen plasma is used to rapidly heat the inflowing third exhaust gas. In particular, the nitrogen plasma may be used to obtain an effect in which some perfluorocompounds such as NF₃ are decomposed by plasma.

The plasma supply unit 233 is provided to generate and supply the plasma. The plasma supply unit 233 includes a plasma torch, generates a plasma flame, and rapidly heats the third exhaust gas.

In addition, a heater other than plasma may be used to heat the third exhaust gas.

The heated third exhaust gas flows into the catalyst unit 234. It is preferable that the catalyst filling the catalyst unit 234 be an alumina-based catalyst for decomposing perfluorocompounds. The catalyst may flow into a metal mesh, and the shape of the metal mesh may be a pallet shape, a cylindrical shape, an H shape, or a honeycomb shape.

The perfluorocompounds passing through the catalyst unit 234 are decomposed to generate byproduct gases such as HF or SiF₄, and thus the perfluorocompounds are decomposed.

In one embodiment, the catalyst treatment unit may be connected to the heat exchange unit.

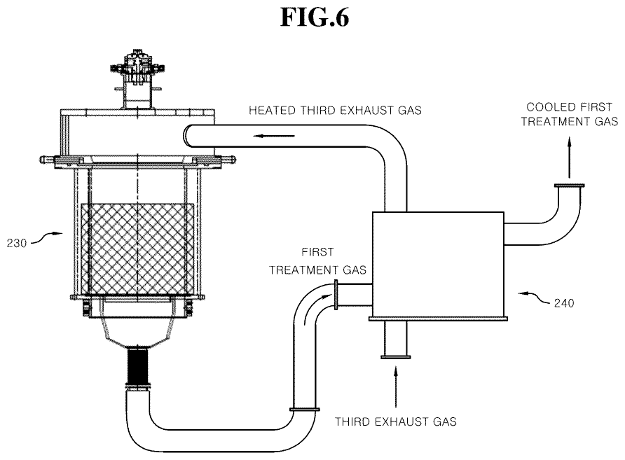

FIG. 6 is a cross-sectional view for describing operations of the catalyst treatment unit and the heat exchange unit according to an example embodiment of the present inventive concept.

Referring to FIG. 6, the third exhaust gas supplied from the dust collecting unit 220 of FIG. 2 flows into the heat exchange unit 240. In addition, the first treatment gas in which the perfluorocompounds are decomposed in the catalyst treatment unit 230 also flows into the heat exchange unit 240.

The first treatment gas has a temperature range of 650° C. to 740° C. and has a higher temperature than the third exhaust gas. Therefore, the first treatment gas is cooled in the heat exchange unit 240 and exhausted as the cooled first treatment gas. In addition, the third exhaust gas is heated in the heat exchange unit 240 and formed into the heated third exhaust gas, and flows into the catalyst treatment unit 230.

As described above, the heated third exhaust gas is supplied to the catalyst treatment unit 230 and heated to 700° C. or more by the plasma torch so that the perfluorocompounds are decomposed through the catalyst. The first treatment gas in which the perfluorocompounds are decomposed flows into the heat exchange unit 240, and the cooled first treatment gas flows into the posttreatment wet-type treatment apparatus of FIG. 1.

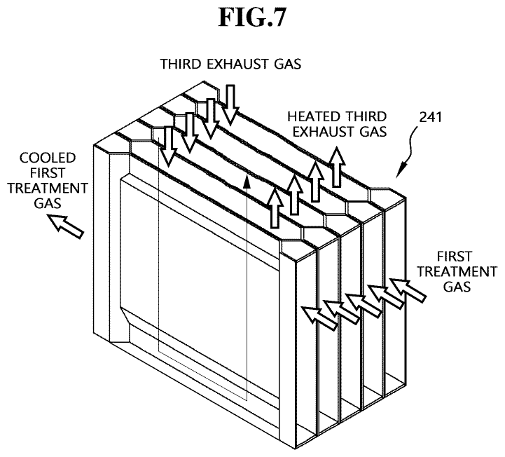

FIG. 7 is a perspective view illustrating the heat exchange unit according to an example embodiment of the present inventive concept.

Referring to FIG. 7, the heat exchange unit is provided in a form in which a plurality of heat transfer plates 241 are bonded to each other. That is, the plurality of heat transfer plates 241 do not have a baffle for controlling an airflow and are provided in a form in which the heat transfer plates 241 having the same shape are bonded to each other.

The first treatment gas that has passed through the catalyst unit in the catalyst treatment unit 230 flows in through a side surface of the heat transfer plate 241. The first treatment gas heated by the catalyst treatment unit to have a temperature of 650° C. to 740° C. flows into the heat transfer plate 241 and is cooled while passing through the heat transfer plate 241 so that the cooled first treatment gas having a temperature range of 230° C. to 280° C. flows out. Directions in which the treatment gases flow are the same.

In addition, the third exhaust gas, which has a relatively low temperature and is supplied from the dust collecting unit 220 of FIG. 2, flows in from one side of an upper portion of the heat transfer plate 241 and flows downward in a separation space between the heat transfer plates 241. In a state in which a bottom surface of the heat exchange unit is sealed or blocked, the third exhaust gas flows along the bottom surface in the same direction as or an opposite direction from the first treatment gas at a lower portion of the separation space between the heat transfer plates 241 to then form an airflow toward the upper portion of the heat transfer plate 241 and then is exhausted toward the upper portion of the heat transfer plate 241. Thus, the third exhaust gas is heated and formed into the heated third exhaust gas having a temperature range of 470° C. to 520° C., and the heated third exhaust gas is exhausted from the heat exchange unit. The exhausted heated third exhaust gas is supplied to the exhaust gas inlet of the catalyst treatment unit 230.

FIG. 8 is a perspective view illustrating the heat transfer plate of FIG. 7 according to an example embodiment of the present inventive concept.

Referring to FIG. 8, the heat transfer plate includes a high temperature gas inlet 242, a high temperature gas outlet 243, a low temperature gas inlet/outlet 244, a heat transfer portion 245, and a low temperature gas guide portion 246.

The first treatment gas flows in through the high temperature gas inlet 242. For the inflow of the first treatment gas, upper and lower covers 247 and side covers 248 are provided to form an open space at one side. The first treatment gas flows in through the open space formed in a side surface, and the first treatment gas flows inside the heat transfer portion 245.

In the heat transfer portion 245, the first treatment gas is formed into the cooled first treatment gas by performing a heat exchange operation of heating the third exhaust gas supplied from the dust collecting unit in a process in which the first treatment gas flows in an x direction. The cooled first treatment gas is exhausted through the high temperature gas outlet 243 disposed at an opposite side. In addition, in order to smoothly exhaust the cooled first treatment gas, the high temperature gas outlet 243 has the upper and lower covers 247 and the side covers 248. In particular, it is preferable that the high temperature gas inlet 242 and the high temperature gas outlet 243 be the same components with a symmetrical structure.

In addition, the high temperature gas inlet 242 and the high temperature gas outlet 243 are directly bonded to the high temperature gas inlet and the high temperature gas outlet of a neighboring heat transfer plate without a separation space. Thus, the heat transfer plates may be disposed at a high density, thereby increasing heat transfer efficiency.

The low temperature gas inlet/outlet 244, the heat transfer portion 245, and the low temperature gas guide portion 246 are disposed between the high temperature gas inlet 242 and the high temperature gas outlet 234. The low temperature gas inlet/outlet 244 is formed in an upper region of the heat transfer plate, the heat transfer portion 245 is disposed at a central portion of the heat transfer plate, and the low temperature gas guide portion 246 is disposed at a lower portion of the heat transfer plate.

The third exhaust gas supplied from the dust collecting unit flows in through the low temperature gas inlet/outlet 244 from above, and an airflow is formed in a y direction. The third exhaust gas is supplied from the dust collecting unit of FIG. 2. The third exhaust gas is heated by flowing downward along a surface of the heat transfer portion 245. The third exhaust gas flowing downward along the surface of the heat transfer portion 245 flows in the low temperature gas guide portion 246. The third exhaust gas that is not exhausted downward due to a lower surface shielding plate 249 flows in the x direction or a-x direction along the lower surface shielding plate 249 and forms an airflow directed upward by colliding with the side cover 248 disposed on a lower surface of the high temperature gas inlet 242.

Accordingly, the third exhaust gas flows in the y direction to undergo a first heating operation and flows in a −y direction to undergo a second heating operation to be formed into the heated third exhaust gas. Therefore, heat exchange efficiency is increased.

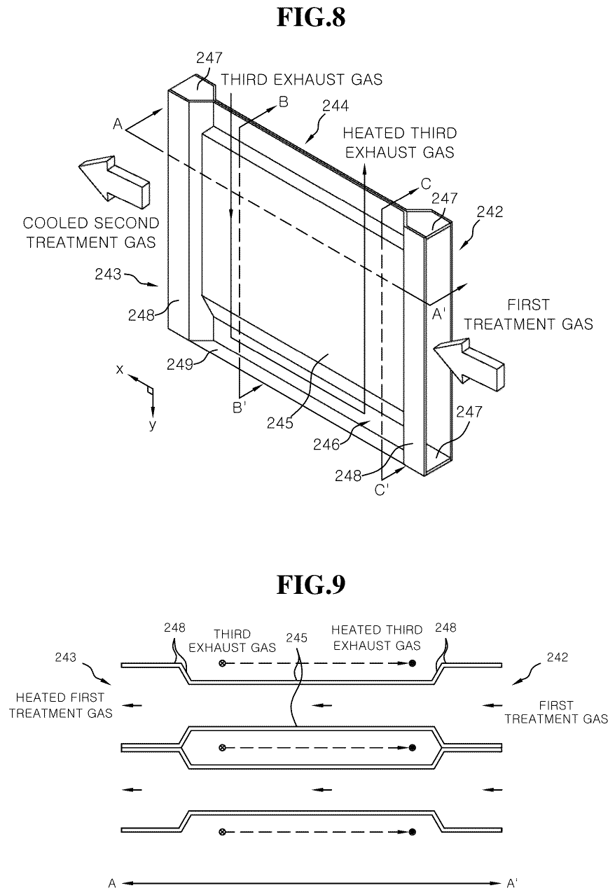

FIG. 9 is a cross-sectional view along line A-A′ of the shape of two bonded heat transfer plates of FIG. 8 according to an example embodiment of the present inventive concept.

Referring to FIG. 9, the first treatment gas flows in through the high temperature gas inlet 242 and flows in a space inside the heat transfer portion 245 to heat the third exhaust gas. In addition, the first treatment gas flows out through the high temperature gas outlet 243 which has a relatively wider cross-sectional area than the heat transfer portion 245. In this case, the third exhaust gas flows in a direction perpendicular to a direction of the first treatment gas. The heat transfer portion 245 connects the high temperature gas inlet 242 and the high temperature gas outlet 243 and forms a fluid path for the first treatment gas.

In particular, the third exhaust gas flows into an area adjacent to the high temperature gas outlet 243 and is primarily heated. In addition, the third exhaust gas flows into the low temperature gas guide portion having a separation distance that is greater than a separation distance between the heat transfer portions 245, moves in a direction opposite to a traveling direction of a treatment gas, and flows again into the separation space between the heat transfer portions 245 from an area adjacent to the high temperature gas inlet 242. Accordingly, secondary heating is performed through the heat transfer portion 245, and the heated third exhaust gas flows out in a direction opposite to an inflow direction of the third exhaust gas.

In particular, the third exhaust gas needs to flow in from an area adjacent to the high temperature gas outlet 243. That is, it is preferable that a path for an airflow of the exhaust gas be formed to pass through an upper region near the high temperature gas outlet 243, the low temperature gas guide portion near the high temperature gas outlet 243, the low temperature gas guide portion near the high temperature gas inlet 242, and an upper region near the high temperature gas inlet 242.

When the exhaust gas flows in adjacent to the high temperature gas inlet 242 in a direction opposite to such a direction, a primary heating operation through the heat transfer portion 245 is smoothly performed, but a secondary heating operation is not smoothly performed due to the first treatment gas cooled in the high temperature gas outlet 243, and thus the efficiency of a heat exchange operation decreases.

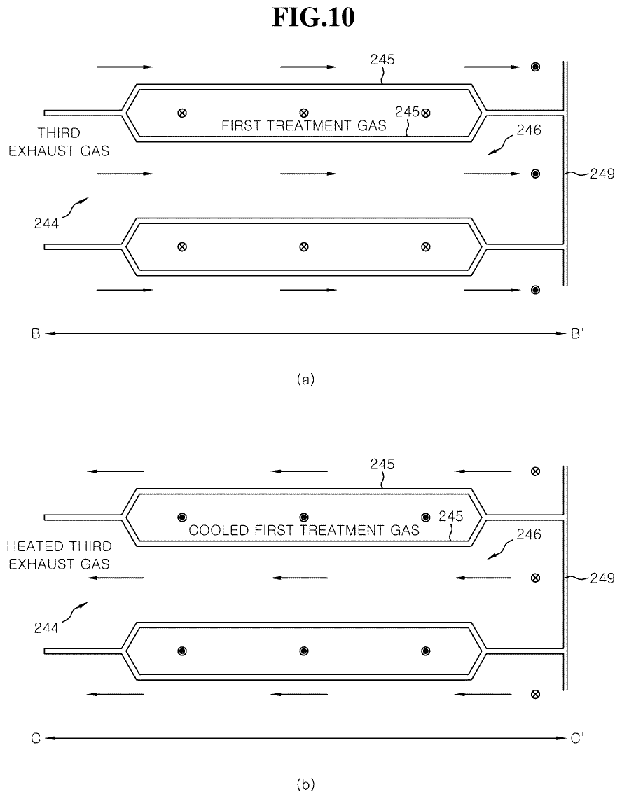

FIG. 10 shows a cross-sectional view along line B-B′ and a cross-sectional view along line C-C′ of the shape of two bonded heat transfer plates of FIG. 8 according to an example embodiment of the present inventive concept.

Referring to of FIG. 10A, the third exhaust gas flows in through the low temperature gas inlet/outlet 244 and is primarily heated while coming into contact with the heat transfer portion 245. The first treatment gas flows in a direction of a ground surface inside the heat transfer portion 245. The exhaust gas flowing along the surface of the heat transfer portion 245 is primarily heated by the heat transfer portion 245, and an airflow collides with the lower surface shielding plate 249 of the low temperature gas guide portion 246 and flows out in a direction away from the ground surface.

Referring to FIG. 10, the primarily heated third exhaust gas that collides with the lower surface shielding plate 249 flows in the low temperature gas guide portion 246, collides with the side cover at a lower portion of the high temperature gas inlet to flow in the separation space between the heat transfer portions 245. Therefore, a secondary heating operation is performed through the heat transfer portion 245. The secondary heating operation is achieved while the primarily heated exhaust gas flows in the separation space between the heat transfer portions 245. In particular, in FIG. 10B, the exhaust gas flows near the high temperature gas inlet, and thus a heating operation is easily performed due to the first treatment gas having a higher temperature than the high temperature gas outlet.

The heat exchange unit may heat the third exhaust gas to be treated through two stages. Therefore, through a heat exchange action, a temperature of the third exhaust gas may be raised as compared to an existing heat exchange action, and the third exhaust gas flows into the catalyst treatment unit in a sufficiently heated state.

In addition, the plasma supply unit of the catalyst treatment unit may rapidly heat the third exhaust gas and improve reactivity with catalyst particles by heating the third exhaust gas heated using a flame.

In the present inventive concept described above, the exhaust gas charging unit is disposed to supply a charged gas to an exhaust gas that has undergone primary wet treatment. Thus, fine particles may be smoothly captured in the dust collecting unit. The third exhaust gas or heated third exhaust gas from which the fine particles are removed flows into the catalyst treatment unit. Since the fine particles are removed, the catalytic treatment unit may effectively decompose perfluorocompounds included in the exhaust gas. In particular, a problem that fine particles are deposited on a catalyst in the catalyst treatment unit and lower the activity of the catalyst is solved by capturing the fine particles in the dust collecting unit. In addition, by-products such as HF generated due to the decomposition of the perfluorocompounds are removed through the posttreatment wet-type treatment apparatus connected to the catalyst treatment apparatus.

What is claimed is:

1. A catalyst treatment apparatus comprising:
an exhaust gas charging unit configured to charge a charging gas including oxygen to form a charged gas;
a dust collecting unit into which a mixed gas, in which a second exhaust gas including 1 vol % or less of oxygen is mixed with the charged gas, flows to perform a dust collecting operation; and
a catalyst treatment unit configured to heat perfluorocompounds in a third exhaust gas exhausted from the dust collecting unit and decompose the perfluorocompounds using a catalyst.

2. The catalyst treatment apparatus of claim 1, wherein the exhaust gas charging unit includes a first electrode and a second electrode, each having a plate shape,
the first electrode and the second electrode are disposed alternately with a separation space, and
the charging gas flows in the separation space.

3. The catalyst treatment apparatus of claim 2, wherein the charging gas includes atmospheric gas or a gas including 20% or more of oxygen.

4. The catalyst treatment apparatus of claim 2, wherein the charged gas is charged into a negative ion and exhausted from the exhaust gas charging unit, and
the second exhaust gas is coupled to the charged gas to flow into the dust collecting unit as the ionized mixed gas.

5. The catalyst treatment apparatus of claim 1, wherein the dust collecting unit includes a discharge electrode and a dust collecting electrode, and
negatively ionized charged particles included in the mixed gas are captured on the dust collecting electrode by a voltage difference between the discharge electrode and the dust collecting electrode.

6. The catalyst treatment apparatus of claim 1, wherein the catalyst treatment unit includes:
a processing chamber;
a plasma supply unit positioned at an upper end of the processing chamber and configured to supply plasma;
an exhaust gas inlet configured to supply the third exhaust gas to the plasma supply unit and heat the third exhaust gas;
a catalyst unit configured to decompose perfluorocompounds included in the heated third exhaust gas; and
a treatment gas outlet configured to exhaust a first treatment gas in which the perfluorocompounds are decomposed by the catalyst unit.

7. The catalyst treatment apparatus of claim 6, wherein the plasma supply unit includes a plasma torch and heats the third exhaust gas having an air flow rate of 2 cubic meter minutes (CMM) or less.

8. The catalyst treatment apparatus of claim 1, further comprising a heat exchange unit which is connected between the dust collecting unit and the catalyst treatment unit, into which the third exhaust gas flows, into which a first treatment gas exhausted from the catalyst treatment unit flows, and which supplies the third exhaust gas heated through a heat exchange action to the catalyst treatment unit.

9. The catalyst treatment apparatus of claim 8, wherein the heat exchange unit includes a plurality of heat transfer plates bonded to each other,
wherein each of the heat transfer plates includes:
a high temperature gas inlet through which the first treatment gas flows in;
a high temperature gas outlet which is opposite to the high temperature gas inlet and through which the first treatment gas is cooled to flow out;
a heat transfer portion which is disposed between the high temperature gas inlet and the high temperature gas outlet, through which the first treatment gas flows, and which heats the third exhaust gas flowing along a surface thereof through two stages;
a low temperature gas inlet/outlet which is positioned on the heat transfer portion, and through which the third exhaust gas flows in and the heated third exhaust gas flows out; and
a low temperature gas guide portion which is opposite to the low temperature gas inlet/outlet and through which the third exhaust gas flows in to flow in a direction opposite to that of the first treatment gas.

10. The catalyst treatment apparatus of claim 9, wherein the heat transfer plate further includes a lower surface shielding plate with which the inflowing third exhaust gas collides and which guides an airflow direction of the third exhaust gas in the direction opposite to that of the first treatment gas.

11. The catalyst treatment apparatus of claim 9, wherein the third exhaust gas flows in adjacent to the high temperature gas outlet, and
the heated third exhaust gas flows out adjacent to the high temperature gas outlet.

12. An exhaust gas treatment system comprising:
a pretreatment wet-type treatment apparatus configured to remove SiO₂ particles, SiF₄ gas, or HF gas included in a first exhaust gas generated in an etching process;
a catalyst treatment apparatus configured to remove perfluorocompounds in a second exhaust gas exhausted from the pretreatment wet-type treatment apparatus; and
a posttreatment wet-type treatment apparatus configured to remove the HF gas included in a first treatment gas exhausted from the catalyst treatment apparatus and generated by decomposing the perfluorocompounds.

13. The exhaust gas treatment system of claim 12, wherein the catalyst treatment apparatus includes:
an exhaust gas charging unit configured to charge a charging gas including oxygen to form a charged gas;
a dust collecting unit into which a mixed gas, in which a second exhaust gas including 1 vol % or less of oxygen is mixed with the charged gas, flows to perform a dust collecting operation; and
a catalyst treatment unit configured to heat perfluorocompounds in a third exhaust gas exhausted from the dust collecting unit and decompose the perfluorocompounds using a catalyst.

14. The exhaust gas treatment system of claim 13, wherein the charging gas includes atmospheric gas or a gas including 20% or more of oxygen.

15. The exhaust gas treatment system of claim 13, wherein the charged gas is charged into a negative ion and exhausted from the exhaust gas charging unit, and
the second exhaust gas is coupled to the charged gas to flow into the dust collecting unit as the ionized mixed gas.

16. The exhaust gas treatment system of claim 13, wherein the catalyst treatment unit includes:
a processing chamber;
a plasma supply unit positioned at an upper end of the processing chamber and configured to supply plasma;
an exhaust gas inlet configured to supply the third exhaust gas to the plasma supply unit and heat the third exhaust gas;
a catalyst unit configured to decompose perfluorocompounds included in the heated third exhaust gas; and
a treatment gas outlet configured to discharge the first treatment gas in which the perfluorocompounds are decomposed by the catalyst unit.

17. The exhaust gas treatment system of claim 13, wherein the catalyst treatment apparatus further includes a heat exchange unit which is connected between the dust collecting unit and the catalyst treatment unit, into which the third exhaust gas flows, into which the first treatment gas exhausted from the catalyst treatment unit flows, and which supplies the third exhaust gas heated through a heat exchange action to the catalyst treatment unit.

18. The exhaust gas treatment system of claim 17, wherein the heat exchange unit includes a plurality of heat transfer plates bonded to each other,
wherein each of the heat transfer plates includes:
a high temperature gas inlet through which the first treatment gas flows in;
a high temperature gas outlet which is opposite to the high temperature gas inlet and through which the first treatment gas is cooled to flow out;
a heat transfer portion which is disposed between the high temperature gas inlet and the high temperature gas outlet, through which the first treatment gas flows, and which heats the third exhaust gas flowing along a surface thereof through two stages;
a low temperature gas inlet/outlet which is positioned on the heat transfer portion, and through which the third exhaust gas flows in and the heated third exhaust gas flows out; and
a low temperature gas guide portion which is opposite to the low temperature gas inlet/outlet and through which the third exhaust gas flows in to flow in a direction opposite to that of the first treatment gas.

19. The exhaust gas treatment system of claim 18, wherein the heat transfer plate further includes a lower surface shielding plate with which the inflowing third exhaust gas collides and which guides an airflow direction of the third exhaust gas in the direction opposite to that of the first treatment gas.

20. The exhaust gas treatment system of claim 19, wherein the third exhaust gas flows in adjacent to the high temperature gas outlet, and
the heated third exhaust gas flows out adjacent to the high temperature gas outlet.
